(19) United States
(12) Patent Application Publication
(10) Pub. No.: US 2011/0087767 A1
(43) Pub. Date: Apr. 14, 2011

(54) Computer Environment Analysis Tool

(75) Inventors: Dmitry Sonkin, Redmond, WA (US); Unmesh Vartak, Sammamish, WA (US); Bjorn B. Levidow, Bellevue, WA (US); Julia Kuzminova, Bellevue, WA (US)

(73) Assignee: Microsoft Corporation, Redmond, WA (US)

(21) Appl. No.: 12/579,066

(22) Filed: Oct. 14, 2009

(51) Int. Cl. G06F 11/20; G06F 17/40; G06F 9/46; G06F 15/173; G06F 17/30

(52) U.S. Cl. 709/224; 702/187; 718/106; 714/E11.071; 707/E17.032; 707/E17.044

(57) ABSTRACT

A computer environment analysis tool may have a modular architecture that comprises data collection modules and data analysis modules. The data collection modules may populate multiple data sets defined by a schema, and the data analysis modules may analyze or interpret the data from the database to produce report output. A reporting module may generate information that may be consumed by a user or other service. The data collection modules may be specialized modules that collect specific types of data from local and remote devices, and the data analysis modules may analyze the data for specific business logic, such as determining if a computer environment is capable of upgrading or deploying various changes.

### BACKGROUND

A computer environment may be a complex infrastructure of devices such as servers, clients, and other network devices. A typical computer environment may be found in a home with a local area network or workgroup, as well as larger enterprises that may have a complex domain based structure that may include multiple sub-domains and subnets.

Within the computer environment, many different servers may provide many different applications and services to other devices. As computer environments evolve and change, the management of the devices within the environment can get complicated, especially when a major change or installation is performed.

Further, as new devices, applications, and services are deployed across the network, the tools used to manage the computer environment may become outdated or obsolete.

### SUMMARY

A computer environment analysis tool may have a modular architecture that comprises data collection modules and data analysis modules. The data collection modules may populate multiple data sets defined by a schema, and the data analysis modules may analyze or interpret the data from the database to produce report output. A reporting module may generate information that may be consumed by a user or other service. The data collection modules may be specialized modules that collect specific types of data from local and remote devices, and the data analysis modules may analyze the data for specific business logic, such as determining if a computer environment is capable of upgrading or deploying various changes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an architecture for a computer environment analysis tool.

FIG. 2 is a diagram illustration of an embodiment showing a usage example of a computer environment analysis tool.

FIG. 3 is a diagram illustration of an embodiment showing a network environment for a computer environment analysis tool.

FIG. 4 is a flowchart illustration of an embodiment showing a method for performing a computer environment analysis.

### DETAILED DESCRIPTION

A computer environment analysis tool may use a modular architecture to gather information about a computer environment and process that information using business logic. The modular architecture may use a schema that defines the data collected by data collection modules and consumed by analysis modules. Once analysis has been performed, the analysis tool may have report modules that may create data that may be consumed by a user or another application.

The architecture of the computer environment analysis tool may be very flexible and adaptable. The data collection modules may be routines that are tailored to collect specific data and return the data according to the schema. In many embodiments, a computer environment analysis tool may have five, ten, twenty, or over one hundred such data collection modules. Similarly, the analysis modules may be configured to perform a very specific analysis using the data. The analysis modules may be configured to reflect specific business logic such as determining if an upgrade is possible for a specific operating system, application, or device.

In a typical use scenario, the computer environment analysis tool may be executed on a device within a network environment. The data collection modules may identify data from the local device as well as other servers, clients, routers, switches, network appliances, and other devices across the network and populate various data sets defined within the schema. A first set of analysis modules may be configured to assess the configuration of the network and devices on the network to identify problems pertaining to the network configuration. A second set of analysis modules may be configured to identify the impact of upgrading a service on a server within the network, and to determine which devices may also be upgraded to access the service.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

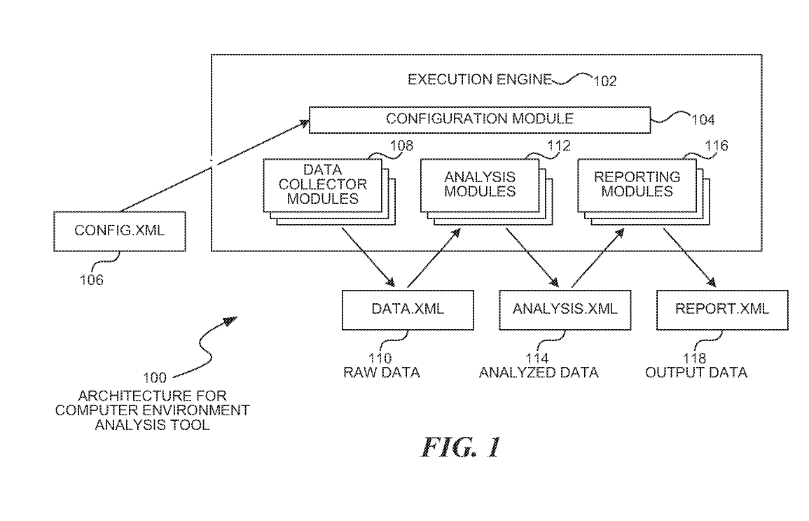

FIG. 1 is a diagram of an embodiment 100 showing a general architecture for a computer environment analysis system. Embodiment 100 is a simplified example of modular and extensible system for gathering and analyzing data about a computing environment.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of an architecture that may gather and analyze computer configuration information. Such a system may gather data about a local device on which the system may execute, as well as remote devices connected to a network. The architecture of embodiment 100 may be extensible, such that additional data may be collected and many different analyses of the data may be performed by adding various modules to the system.

The architecture of embodiment 100 may use various schemas to define the input and output of each group of modules. The schema may define the data structure populated by one group of modules and consumed by another.

An execution engine 102 may manage the sequencing and execution of the various components of the system. In many embodiments, the execution engine 102 may identify various dependencies between different modules and create an execution order based on those dependencies. The execution engine 102 may then cause the various modules to be executed according to the execution order.

The execution engine 102 may have a configuration module 104 that may use a configuration definition 106. The configuration definition 106 may be a file that identifies the various modules to be performed, as well as any dependencies and options that may be identified for the various modules.

The execution engine 102 may manage several different types of modules, including data collector modules 108, analysis modules 112, and reporting modules 116. The data collector modules 108 may populate raw data 110, which is consumed by the analysis modules 116 to populate analyzed data 114, which is consumed by the reporting modules 116 to populate the output data 118.

Each set of modules may use a schema to define the data that is produced or consumed by the modules. Specifically, a schema may be used to define the raw data 110 and analyzed data 114. In some embodiments, a schema may be used to define the output data 118.

The use of a defined schema allows a data collector module to be developed and tested separately from other modules. The data collector module may be upgraded, modified, and replaced by a new data collection module without changing the downstream analysis and reporting modules because the data passed downstream conforms to the schema.

The modular architecture allows the same analysis modules to be used on systems with different hardware and software by changing the data collector modules. Similarly, the same data collector modules may be used in different types of analyses by changing the analysis modules.

The architecture of embodiment 100 may be viewed in three layers. The first layer may be the data access layer which collects data from many different sources and populates a database exemplified as the raw data 110. The second layer may be the business logic layer embodied in the analysis modules 112. The third layer may be the user interface layer embodied in the reporting modules 116.

The analysis modules 112 may be configured as business logic by defining a group of analysis modules to address a specific business goal. In one use scenario, the data collection modules 108 may collect configuration data for many different devices within a local area network. Business logic may be defined by configuring a group of analysis modules 112 to analyze network configuration for certain best practices, to determine if hardware devices may be capable of upgrading to new versions of a software application, or to identify client devices that may be upgraded when a server application is deployed, for example.

The business logic defined by the analysis modules 112 may be used for any type of analysis for a predefined business purpose. Because the analysis modules 112 use the raw data 110 defined by a schema, the raw data 110 may be used by multiple groups of analysis modules 112 to perform various analyses on the same raw data 110.

The data collector modules 108 may gather data to populate the raw data 110. In many embodiments, the data collector modules 108 may be highly tailored and limited function routines that may collect a specific type of data. For example, in a server environment, a Lightweight Directory Access Protocol (LDAP) application may provide credential services to client devices that attach to the network, among other functions. A data collector module 108 may perform the function of collecting user specific information from the LDAP application and populating the raw data 110. Another data collection module 108 may perform the function of collecting device information from the LDAP application and populating the raw data 110.

When the various modules are small and highly specialized, the modules may be easily written, tested, and updated in the future. In general, the smaller the task performed by a module, the less complex the module may be, and the development and maintenance costs may be minimized.

The reporting modules 116 may consume the analyzed data 114 and produce output data 118. In many cases, the output data 118 may be in a form that is human readable. In some cases, the output data 118 may be in a form that may be consumed by another application.

In one use scenario, the computer environment analysis tool of embodiment 100 may be used to prior to installing an application on a client, server, or other device. The computer environment analysis tool may analyze the network environment, the hardware and software capabilities within the network environment, and may generate a list of changes or upgrades that may be performed prior to installing the desired application. The installation process may start with the computer environment analysis tool, which may generate output data 118 that may be used by an installation routine to create a list of upgrades, then cause those upgrades to be performed along with the desired application.

In such a use scenario, the output data 118 may be consumed directly by an installation manager that causes the upgrades to be performed.

In many embodiments, one or more of the configuration definition 106, raw data 110, analyzed data 114, and output data 118 may be in XML or other text based language. In such embodiments, each data definition may be defined using an XML based schema language, such as RELAX NG, Document Type Definition (DTD), Document Definition Markup Language (DDML), Document Schema Definition Language (DSDL), Document Structure Definition (DSD), Namespace Routing Language (NRL), Schema for Object Oriented XML (SOX), XSD, WXS, or other schema language.

The various configuration definition 106, raw data 110, analyzed data 114, and output data 118 may be defined in terms of a relational database that contains instances of tables and rows within those tables. In some cases, a database management system may be used to store and retrieve the data.

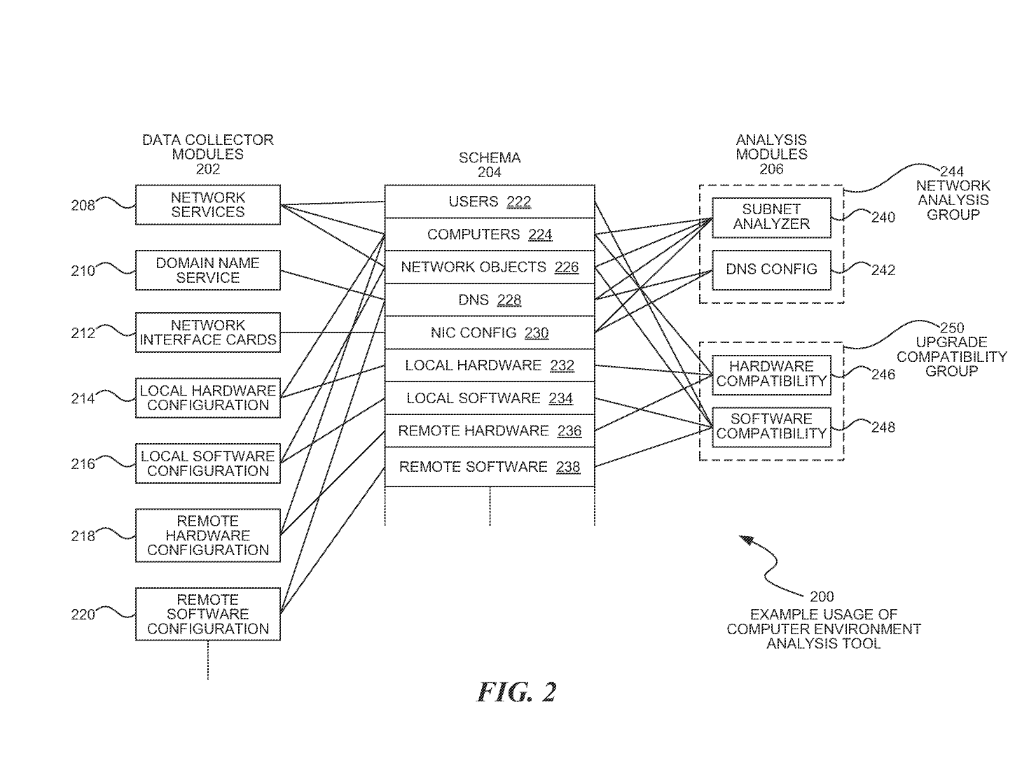

FIG. 2 is a diagram of an embodiment 200 showing an example usage of a computer environment analysis system. Embodiment 200 is a simplified example of various data collector modules, schema, and analysis modules that may be used to perform several analysis defined by business logic.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 may be a specific example of various data collector modules 202, schema 204, and analysis modules 206 that may analyze a computer network environment for various business purposes.

Embodiment 200 may be an example of a computer environment analysis tool that may be used to identify misconfigured devices or perform other maintenance operations, as well as analyze the computer environment for upgrades or other functions.

The example of embodiment 200 is merely a subset of the possible data collector modules, schema, and analysis modules that may be used in a computer environment analysis tool. These examples are meant to show how such a tool may be used, and other embodiments may have different use scenarios and correspondingly different data collector modules, schema, and analysis modules.

The data collector modules 202 may be specialized applications, functions, routines, processes, or other mechanisms that collect specific data and populate a data set within the schema 204. In some embodiments, the data collector modules may be applications that operate separately from an execution engine but may be launched or controlled by the execution engine. In some embodiments, a data collector module may be a function that is called within an execution engine.

In still other embodiments, a data collector module may be called by an execution engine but executed at least in part on another device. For example, some data collector modules may be applications or functions that operate on a client device and communicate with an execution engine or with a data collector module that operates on the same device as the execution engine.

Several examples of data collector modules 202 are illustrated. In general, the data collector modules 202 may locate a data source, gather information from the data source, format or process the data in accordance with the schema 204, and store the data in a data set within the schema 204.

A network services data collector module 208 may search and find an LDAP or other network services provider and collect data relating to users 222, computers 224, and other network objects 226. Many LDAP and similar services may maintain a database of users, computers, and network objects, and the network services data collector module 208 may first perform a search for the network services provider, then perform one or more queries to collect the desired data. Once the data are collected, they may be formatted and organized according to the schema 204 to populate the data sets for users 222, computers 224, and other network objects 226.

The network services data collector module 208 may be an example of a data collector module that populates multiple data sets within the schema 204.

A domain name service data collector module 210 may find all the instances of a domain name service within a local area network, for example, and populate a DNS data set 228. In many cases, a data collector module may populate multiple instances of an object defined in a schema. For example, the DNS data collector module 210 may find two or more DNS servers within a local area network. For each of the DNS servers, the DNS collector module 210 may create an entry within a DNS data set 228 for the DNS server. In the case of two DNS servers, two rows may be included in a DNS data set. In other embodiments, the schema 204 may be defined so that separate data sets may be created for each DNS server.

The DNS data collector module 210 is an example of a data collector module that may populate a single data set within the schema 204. In many cases, a data collector module 202 may be limited in scope to gather a single type of data. In some cases, such as with the network services data collector module 208, a single data collector module may populate several different data sets.

The network interface card (NIC) data collector module 212 may gather configuration information about network interface cards on a local device as well as other devices connected to a network. In some embodiments, the NIC data collector module 212 may be capable of performing a query across a network connection to gather the NIC configuration settings for devices. In other embodiments, the NIC data collector module 212 may perform a query to a process running on each device to gather NIC data. In some such embodiments, the NIC data collector module 212 may transmit an executable program to the devices that may gather the NIC data and transmit the NIC data to the data collector module on the local device. The NIC data collector module 212 may populate a NIC configuration data set 230 within the schema 204.

The local hardware configuration data collector module 214 and local software configuration data collector module 216 may gather hardware and software configuration information about a local device. The local device may be the device on which the execution engine of a computer environment analysis tool may be operating.

The data collector modules 214 and 216 may each be groups of smaller data collection modules that search for specific types of hardware and software information. For example, the hardware configuration data collector module 214 may be made up of a data collector module that gathers network related information, a separate data collection module that gathers processor information, and other data collector modules that gather BIOS information, storage information, peripheral information, and other hardware specific information.

In some embodiments, a data collector module may include separate data collector modules that are specifically configured for different hardware or software configurations. For example, a local software data collector module may include a module that queries to determine the operating system. Based on the operating system, a data collector module tailored to the specific operating system may be launched. In some embodiments, additional data collector modules may be launched when certain configurations are encountered.

For example, a software data collector module may perform an initial scan to determine the installed applications on a device. When certain installed applications are encountered, additional data collector modules may be launched to collect data from specific applications. For example, if an email processing application were encountered, a data collector module customized for that application may be launched to gather information from the application.

The local hardware configuration data collector 214 may populate a local hardware data set 232. Similarly, the local software configuration data collector 216 may populate a local software data set 234.

The remote hardware configuration data collector module 218 and remote software configuration data collector module 220 may gather hardware and software configuration data, respectively, from devices available across a network. The data collector modules 218 and 220 may operate by performing queries to the devices, by accessing applications or processes that execute on those devices, or by transmitting an executable that operates on the device. The data collector modules 218 and 220 may perform similar operations as data collector modules 214 and 216, but for other devices than the one on which an execution engine may operate.

In some embodiments, data collector modules may have dependencies on other data collector modules. For example, the remote hardware configuration data collector module 218 may use the output from and therefore depend on the network services data collector module 208. In such a case, the network services data collector module 208 may identify devices on the network and populate the computers data set 224, then the remote hardware configuration data collector module 202 may collect data from each of the computers defined in the computer data set 224. In such a case, the remote hardware configuration data collector module 218 may be defined as dependent on the computers data set 224.

The remote hardware configuration data collector module 218 may populate a remote hardware data set 236. Similarly, the remote software configuration data collector 220 may populate a remote software data set 238. In many embodiments, the remote software data set 238 may include separate instances of a data set for each remote device.

In many embodiments, the data collector modules 202 may gather more information than may be used by the analysis modules 206. In such embodiments, the data collector modules 202 may populate the database defined by schema 204 and keep the database up to date on a periodic or continual basis, and then various analysis modules 206 may be executed when the analysis is desired.

In one use scenario of such an embodiment, the data collector modules 202 may be executed on a regular basis to keep the database up to date. In some such embodiments, the data collector modules may be executed on a scheduled basis, while in other embodiments, the data collector modules may be triggered when a change is detected to a component. For example, a new computer that is added to the network may trigger a data collector module to be executed against it and update the database defined by schema 204 accordingly.

When the database defined by the schema 204 is kept up to date, the analysis modules 206 may be executed on a scheduled basis. For example, a daily or weekly status report may be generated by running a group of analysis modules 206 against the database. Such an embodiment may be useful when the data collection operation may be complex, time consuming, and where the data do not change very often.

In some embodiments, the data collector modules 202 may be executed when an analysis is desired. Such an embodiment may be useful when the data may change quickly, when the data collection process may not take a long time to perform, or when the most current data is desired. For example, an embodiment that operates as part of a software installation process may have the data collector modules executed just prior to performing the analysis modules. Such an embodiment may also be tailored to the specific installation process and may or may not reuse the data for subsequent analyses.

In the example of embodiment 200, two different groups of analysis modules are illustrated. A network analysis group 244 may perform a check of the network topology and may include a subnet analyzer 240 and DNS configuration checker 242. An upgrade compatibility group 250 may test devices for compatibility for an upgrade and may include a hardware compatibility check 246 and a software compatibility check 248.

The groups of analysis modules may be configured to address specific business logic. In the examples of embodiment 200, the network analysis group 244 and upgrade compatibility group 250 may each perform different business functions using the same database.

Since the analysis modules 206 consume various datasets, dependencies between the analysis modules and data sets may be defined. For example, the subnet analyzer 240 may depend on the computers data set 224, the network objects data set 226, the DNS data set 228, and the NIC configuration data set 230. The DNS configuration checker 242 may depend on the DNS data set 228 and the NIC configuration data set 230.

Similarly, the hardware configuration checker 246 may depend on the computers data set 224, the local hardware data set 232, and the remote hardware data set 236. The software configuration checker 248 may depend on the users data set 222, the computers data set 224, the network objects data set 226, the local software data set 234, and the remote software data set 238.

In some embodiments, a first analysis module may be defined to be dependent on a second analysis module. In such a case, the second analysis module may be executed first, and the results used by the first analysis module.

In many embodiments, an execution engine may identify the various dependencies and construct an execution order based on the dependencies.

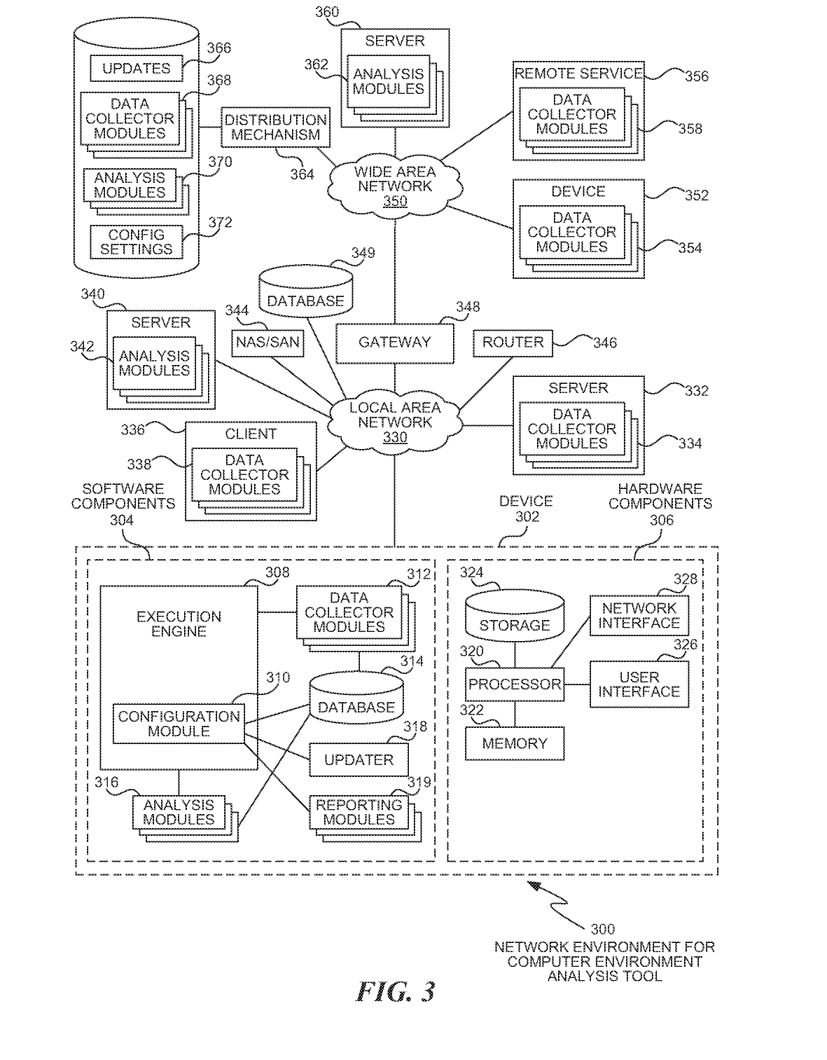

FIG. 3 is a diagram of an embodiment 300 showing an environment in which a computer environment analysis tool may operate. Embodiment 300 is an example of a local area network and wide area network in which various components of a computer environment analysis tool may operate.

The diagram of FIG. 3 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 300 illustrates a network environment in which different components of a computer environment analysis tool may operate. In some cases, various modules may be executed on different devices, or the modules may be affected by different devices.

A device 302 may have software components 304 and hardware components 306. The device 302 may represent any type of computing device, such as a server, client, desktop computer, laptop computer, personal digital assistant, network appliance, or other device. In some instances, the device 302 may be a handheld device such as a cellular telephone, handheld scanner, mobile tablet computer, or other device.

The software components 304 may include an execution engine 308 which may include a configuration module 310. The execution engine 308 may control or manage various data collector modules 312 and analysis modules 316 to deliver some output. The execution engine 308 may operate like the execution engine 102 presented in embodiment 100.

The data collector modules 312 and analysis modules 316 may be locally executed modules. A locally executed module is a module that executes on the same hardware components 306 as the execution engine 308. In some embodiments, the locally executed module may operate in the same or different processor or processor thread as the execution engine.

The data collector modules 312 may collect data that are stored in a database 314 and consumed by the analysis modules 316. In some embodiments, the analysis modules 316 may store the analyzed data in the database 314 or may output the data to another database or in another form. Reporting modules 319 may be used to create a user readable report of the analysis, prepare the analyzed data for use by another application, or other further processing.

The device 302 may have several hardware components 306. The hardware components 306 may include a processor 320, random access memory 322, nonvolatile memory 324, as well as a user interface 326 and a network interface 328. The hardware components 306 are examples of a hardware platform that may execute the software components 304 and may represent many different devices that may have a processor and other computing components.

In many embodiments, the computer environment analysis tool may operate on a local device 302 and connect to other devices using a local area network 330. The local area network 330 may be a network inside a corporation, company, enterprise, home, or other organization. Typically, the devices connected to the local area network 330 may share services across the network or otherwise interact with each other.

Some embodiments may also interact with remote devices that are connected through a gateway 348 to a wide area network 350. A wide area network 350 may be a network, such as the Internet, where devices connected to the network may be outside the control of a single organization. In many cases, a computer environment may include servers and remote services that are used from a local area network. Examples of such services may include remotely hosted email services, web based applications, offsite storage services, and other services.

In many cases, data collection modules may operate in whole or in part on other devices. For example, the server 332 is connected to the local area network 330 and may have data collector modules 334. Similarly, the client 336 may have data collector modules 338. In both cases, the data collector modules 334 and 338 may be locally operating programs or services that may respond to the execution engine 308. In cases where remotely hosted services are present, a remote device 352 may have data collector modules 354 or a remote service 356 may have data collector modules 358.

In some embodiments, a locally running data collector module 312 may communicate with the remote data collection modules in several different manners. In one manner, the remote data collection modules may be started and stopped by the execution engine 308, and the execution engine 308 may send communications to the data collection modules to send configuration information and receive raw data for populating the database 314. Such data collection modules may be applications or services that may be installed on the various remote devices prior to running the execution engine.

In some cases, the execution engine 308 may be configured to distribute the data collection modules to the remote devices and cause the modules to operate. The execution engine 308 and the remote devices may be configured such that the execution engine 308 may push an executable to the remote devices for execution. Some embodiments may be configured to send a communication to the remote devices and the remote devices may be capable of downloading and running the data collector modules.

Remote data collection modules may be pre-installed executable programs that can be called from the execution engine. In such cases, a set of data collector modules may be distributed as part of a software application, operating system, or client application, and the modules may be called by a communication from an execution engine to the device that hosts the data collector.

In many cases, a data collector module may query another device to gather data. For example, one of the locally executing data collector modules 312 may query a NAS or SAN storage device 344, a router 346, or a gateway 348 to collect performance statistics, hardware or software capabilities, configuration information, or other data. Some data collector modules operating on a second device may perform a query to a third device to collect data.

In some embodiments, some analysis modules may be located locally, such as analysis modules 316, while other analysis modules 342 may be located on a local area network server 340 or on a wide area network server 360 as analysis modules 362.

In such embodiments, some or all of the analysis modules that make up a business logic process may be performed remotely. In the example of a network analysis group 244 of embodiment 200, the subnet analyzer 240 may be performed remotely while the DNS configuration checker 242 may be performed locally.

Many computer environment analysis tools may have a distribution mechanism 364 and an updater 318. The updater 318 may periodically receive updates 366, data collector modules 368, analysis modules 370 and configuration settings 372 from the distribution mechanism 364. In some embodiments, the updater 318 may periodically query the distribution mechanism 364 to download new components, while in other embodiments, the distribution mechanism 364 may push updated components to the updater 318 as new components are available.

In some embodiments, remote devices that execute data collector modules or analysis modules may download various components on demand from the distribution mechanism 364. For example, the execution engine 308 may cause the server 332 to download and install the data collector modules 334, then cause the data collector modules 334 to execute. In some cases, the data collector modules 334 may be uninstalled, while in other cases, the data collector modules 334 may be retained and used again later.

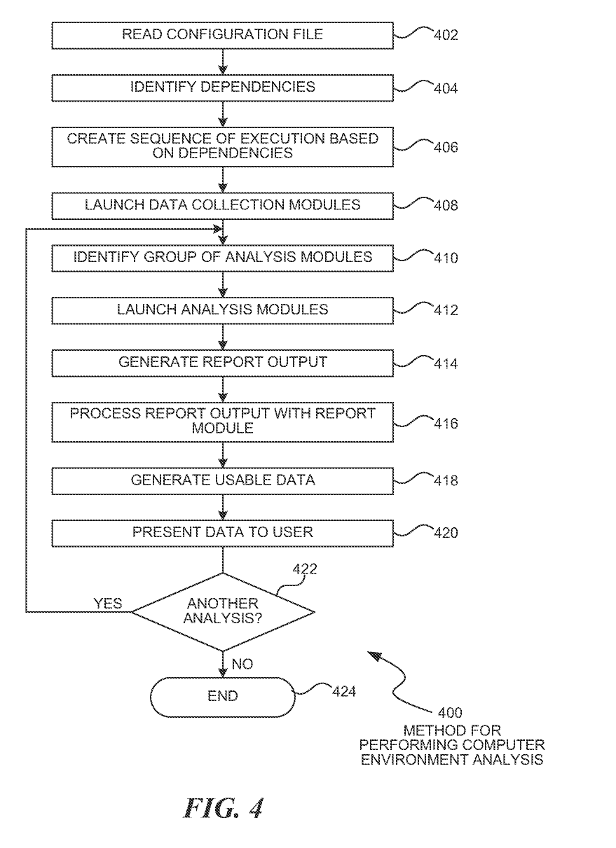

FIG. 4 is a flowchart illustration of an embodiment 400 showing a method for performing a computer environment analysis. Embodiment 400 is a method that may be performed by a computer environment analysis tool such as the computer environment analysis tool described in embodiments 100, 200, and 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process of embodiment 400 is an example of the process that may be coordinated by an execution engine. Some of the operations, such as data collection, analysis, and reporting may be performed by data collection modules, analysis modules, and reporting modules, respectively. The execution engine may coordinate these modules and cause them to operate in a specific sequence or order of execution.

In block 402, a configuration file may be read. The configuration file may include a definition of the data sets to be populated, data collector modules to populate those data sets, analysis modules that may consume the data sets, and reporting modules that may further process the analyzed data.

The data sets to be populated may be defined by a name, assembly, and class. The name may be friendly name or other identifier that is user readable and easy to comprehend. The assembly and class may refer to a dynamic linked library and class definition within that dynamic linked library.

The data collector modules may be similarly defined by a friendly name, assembly, and class. Data collector modules may also have an associated data set defined. The data set definition may be the friendly name of one of the data sets defined in the configuration file and may serve as a dependency between the data set and the data collector module.

The analyzer modules may also be defined using a friendly name, assembly, and class. The analyzer module may also have an associated data set defined. The data set definition may be the friendly name of one of the data sets defined in the configuration file and may serve as a dependency between the data set and the analysis module.

The configuration file may be defined in XML or some other language.

In block 404, the dependencies within the configuration file may be identified. The dependencies may be defined by the dependencies of an analysis module to a data set and the data set to the data collector module. In some cases, an analysis module may be dependent on two or more data sets, and each data set may be dependent on two or more data collection modules.

In many cases, one analysis module may depend on another analysis module. For example, one analysis module may produce output that is further analyzed by a second analysis module. Similarly, some reporting modules may depend on other reporting modules.

Similarly, a data collection module may be dependent on a second data collection module. For example, the remote hardware configuration data collection module 218 of embodiment 200 may be dependent on the results of the network services data collector module 208.

Using all of the dependencies, a sequence of execution may be defined in block 406. The sequence of execution may identify a serial sequence of execution or may identify two or more modules that may be performed in parallel. In many cases, two or more data collection modules or analysis modules may be capable of operating at the same time, including when those modules are performed by different devices.

The data collection modules may be launched in block 408. In some embodiments, an execution engine may cause several of the data collection modules to be executed in parallel. In cases where some data collector modules depend on other data collection modules, the operation of block 408 may involve sequencing the data collection modules in order.

After the data collection modules complete the data collection in block 408, a group of analysis modules may be identified in block 410, and they may be launched in block 412. The analysis modules may generate report output in block 414.

The analysis modules of block 412 may be performed in sequence according to any dependencies between analysis modules.

After the analysis modules are completed and the report output is generated in block 414, the report output may be processed by reporting modules in block 416. As with the other modules, the reporting modules may be executed in sequence if there are dependencies between reporting modules.

The output of the reporting modules may be usable data in block 418, which may be presented to a user in block 420.

If another analysis is to be performed in block 422, the process may return to block 410 to apply another group of analysis modules. If no further analysis is to be performed, the process may end in block 424.

In blocks 408, 412, and 416, an execution engine may cause the respective modules to be performed according to the dependencies. In many embodiments, the execution engine may cause the modules to be performed in order of their dependencies. However, if a module fails, the execution engine may identify and skip any modules that depend on the failed module.

Embodiment 400 illustrates an example of a system where the data may persist and may be analyzed by multiple groups of analysis modules. Each group of analysis modules may perform a different and sometimes unrelated analysis of the same data to accomplish different business goals using different business logic.

Other embodiments may process a single group of analysis modules. Such embodiments may perform a dependency analysis to identify those data collection modules that produce the data sets consumed by the analysis modules. Such embodiments may identify a subset of data collection modules to execute so that only the desired data is collected. This compares with the embodiment 400 where a very large database may be populated and a subset of the database may be analyzed by each group of analysis modules.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A computer environment analysis tool comprising:
an execution engine operable on a first computer processor within a first device, said execution engine configured to cause data collection modules, analysis modules, and reporting modules to operate;
a first schema defining a plurality of data sets;
a plurality of said data collection modules, each of said data collection modules being configured to perform a data collection operation and populate at least one of said data sets;
a plurality of said analysis modules, each of said analysis modules being configured to perform an analysis and generate a report output, said analysis being dependent on at least one of said data sets; and
at least one reporting module configured to generate output data based on said report output.

2. The tool of claim 1, said execution engine being further configured to:
define a set of dependencies comprising dependencies between said analysis modules and said data sets, and between said data sets and said data collection modules;
use said set of dependencies to determine an order for executing said data collection modules and said analysis modules; and
cause said data collection modules and said analysis modules to be executed according to said order for executing.

3. The tool of claim 2, at least a portion of said set of dependencies being defined in a configuration file readable by said execution engine.

4. The tool of claim 2, said execution engine being further configured to:
identify a failed module and to remove a module dependent on said failed module from said order for executing.

5. The tool of claim 4, at least two of said data collection modules being executed in parallel.

6. The tool of claim 4, at least one of said data collection modules being dependent on a second of said data collection modules.

7. The tool of claim 4, at least one of said data collection modules being executed at least in part on a second processor within a second device.

8. The tool of claim 7, said first device and said second device being connected using a network connection.

9. The tool of claim 2, at least one of said analysis modules being operated on a second processor.

10. The tool of claim 2, said schema defining a relational database comprising tables, said tables being populated at least in part by said data collection modules.

11. The tool of claim 2, said data collection modules comprising at least one of a group composed of:
a domain manager data collection module;
a network interface card data collection module;
a domain name service data collection module;
a local hardware data collection module;
a local software data collection module;
a remote hardware data collection module; and
a remote software data collection module.

12. The tool of claim 2, said analysis modules being defined to accomplish a predefined business logic.

13. The tool of claim 12, said predefined business logic comprising analyzing a network of devices for proper configuration.

14. The tool of claim 12, said predefined business logic comprising analyzing compatibility for a potential software installation.

15. A method comprising:
receiving a configuration file, said configuration file comprising:
identifiers for a plurality of data collection modules and a plurality of analysis modules;
identifying at least one dependency for each of said data collection modules, said dependency comprising a data set populated by said data collection module;
identifying at least one of said dependencies for each of said analysis modules, said dependency comprising a data set consumed by said analysis module;
determining a sequence of execution, said sequence determined by:
sorting each of said dependencies to create a set of dependencies; and
identifying at least one starting module;
causing said data collection modules to be executed according to said sequence of execution, said data collection modules performing at least the functions of:
collecting software configuration data and hardware configuration data for a local device;
collecting software configuration data and hardware configuration data for a device connected to a network connection to said local device;
receiving data from each of said data collection modules, said data being organized according to a schema;
causing said analysis modules to be executed according to said sequence of execution, said analysis modules generating reportable data; and
generating a report comprising said reportable data.

16. The method of claim 15, at least one of said data collection modules being at least partially performed by a remote device.

17. The method of claim 16, said at least one of said data collection modules being fully performed by said remote device.

18. A computer environment analysis tool comprising:
an execution engine operable on a first computer processor within a first device, said execution engine configured to cause data collection modules, analysis modules, and reporting modules to operate;
a first schema defining a plurality of data sets;
a plurality of said data collection modules, each of said data collection modules being configured to perform a data collection operation and populate at least one of said data sets;
a plurality of said analysis modules, each of said analysis modules being configured to perform an analysis and generate a report output, said analysis being dependent on at least one of said data sets;
a first group definition comprising identifiers and dependencies for a first set of said analysis modules, said first group definition comprising a first business logic;
a second group definition comprising identifiers and dependencies for a second set of said analysis modules, said second group definition comprising a second business logic;
at least one reporting module configured to generate output data based on said report output;
said execution engine being further configured to:
define a set of said dependencies comprising dependencies between said analysis modules and said data sets, and between said data sets and said data collection modules;
use said set of dependencies to determine an order for executing said data collection modules and said analysis modules;
cause said data collection modules to be executed according to said order for executing; and
cause said first set of said analysis modules to be executed according to said first group definition.

19. The tool of claim 18, said execution engine being further configured to:
cause said second set of analysis modules to be executed according to said second group definition.

20. The tool of claim 19, a first analysis module being in both said first set and said second set, and a second analysis module being in said first set but not said second set.
